(19) United States
(12) Patent Application Publication
(10) Pub. No.: US 2015/0097772 A1
(43) Pub. Date: Apr. 9, 2015

(54) Gaze Signal Based on Physical Characteristics of the Eye

(71) Applicant: Thad Eugene Starner, Mountain View, CA (US)

(72) Inventor: Thad Eugene Starner, Mountain View, CA (US)

(21) Appl. No.: 13/673,603

(22) Filed: Nov. 9, 2012

Related U.S. Application Data
(60) Provisional application No. 61/584,075, filed on Jan. 6, 2012.

(51) Int. Cl. G06F 3/01

(52) U.S. Cl. CPC G06F 3/013
USPC 345/158

(57) ABSTRACT

A computing device may receive an eye-tracking signal or gaze signal from an eye-tracking device. The gaze signal may include information indicative of observed movement of an eye. The computing device may make a determination that movement of the eye derived from analyzing the received gaze signal violates a set of rules for eye movement, where the set of rules may be based on an analytical model of eye movement. In response to making the determination, the computing device may provide an indication that the received gaze signal contains unreliable eye-movement information for at least one computer-implemented application that uses measured eye movement as an input.

### CROSS-REFERENCE TO RELATED APPLICATIONS

This application claims priority under 35 U.S.C. §119(e) to U.S. Provisional Patent Application Ser. No. 61/584,075, filed on Jan. 6, 2012, which is incorporated herein in its entirety by reference.

### BACKGROUND

Unless otherwise indicated herein, the materials described in this section are not prior art to the claims in this application and are not admitted to be prior art by inclusion in this section.

Various technologies can be utilized to provide users with electronic access to data and services in communication networks, as well as to support communication between users. For example, devices such as computers, telephones, and personal digital assistants (PDAs) can be used to exchange information over communication networks including the Internet. Communication networks may in turn provide communication paths and links to servers, which can host applications, content, and services that may be accessed or utilized by users via communication devices. The content can include text, video data, audio data and/or other types of data.

### SUMMARY

In one aspect, an example embodiment presented herein provides, in a computing device, a computer-implemented method comprising: at the computing device, receiving a gaze signal from an eye-tracking device, the gaze signal including information indicative of observed movement of an eye; at the computing device, making a determination that movement of the eye derived from analyzing the received gaze signal violates a set of rules for eye movement, the set of rules being based on an analytical model of eye movement; and responsive to making the determination, providing an indication that the received gaze signal contains unreliable eye-movement information for at least one computer-implemented application that uses measured eye movement as an input.

In another aspect, an example embodiment presented herein provides a computing device comprising: one or more processors; memory; and machine-readable instructions stored in the memory, that upon execution by the one or more processors cause the system to carry out operations comprising: receiving a gaze signal from an eye-tracking device, wherein the gaze signal includes information indicative of observed movement of an eye, making a determination that movement of the eye derived from analyzing the received gaze signal violates a set of rules for eye movement, wherein the set of rules is based on an analytical model of eye movement, and responding to making the determination by providing an indication that the received gaze signal contains unreliable eye-movement information for at least one computer-implemented application that uses measured eye movement as an input.

In yet another aspect, an example embodiment presented herein provides a non-transitory computer-readable medium having instructions stored thereon that, upon execution by one or more processors of a computing device, cause the computing device to carry out operations comprising: at the computing device, receiving a gaze signal from an eye-tracking device, wherein the gaze signal includes information indicative of observed movement of an eye; at the computing device, making a determination that movement of the eye derived from analyzing the received gaze signal violates a set of rules for eye movement, wherein the set of rules is based on an analytical model of eye movement; and responsive to making the determination, providing an indication that the received gaze signal contains unreliable eye-movement information for at least one computer-implemented application that uses measured eye movement as an input.

In still another aspect, an example embodiment presented herein provides a wearable computing system comprising: an interface for a first sensor configured to obtain eye-movement data; and a processor configured to: compare the eye-movement data to one or more rules for eye movement, wherein the one or more rules are based on physical parameters of an eye; and responsive to determining that the eye-movement data violates at least one of the one or more rules, provide an indication that the eye-movement data is unreliable for at least one computer-implemented application that uses measured eye movement as an input.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrative embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF DRAWINGS

FIG. 1a is a first view of an example wearable head-mounted display, in accordance with an example embodiment.

FIG. 1b is a second view of the example wearable head-mounted display of FIG. 1a, in accordance with an example embodiment.

FIG. 1c illustrates another example wearable head-mounted display, in accordance with an example embodiment.

FIG. 1d illustrates still another example wearable head-mounted display, in accordance with an example embodiment.

FIG. 2 is block diagram of a wearable head-mounted display, in accordance with an example embodiment.

FIG. 3 is a simplified block diagram of a communication network, in accordance with an example embodiment.

FIG. 4a is a block diagram of a computing device, in accordance with an example embodiment.

FIG. 4b depicts a network with clusters of computing devices of the type shown in FIG. 4a, in accordance with an example embodiment.

FIG. 5 is a conceptual illustration of eye tracking using controlled glints, and of ambient light interference with controlled-glint eye tracking, in accordance with an example embodiment.

FIG. 6 is a conceptual illustration of eye tracking based on video frame capture, and of ambient light interference with video tracking, in accordance with an example embodiment.

FIG. 7 is a flowchart illustrating an example embodiment of a method for gaze signal based on physical characteristics of an eye.

### DETAILED DESCRIPTION

1. Overview

In accordance with example embodiment, an eye-tracking system may include an eye-tracking device that observes eye movement or one or more eyes, and converts the observations into an output signal, referred to as a “gaze signal” (also referred to as a “eye-tracking signal”). The gaze signal may be communicated to a computing device that can analyze the gaze signal to recover the observed eye motion.

In accordance with example embodiments, the eye-tracking system may measure at least two primary types of voluntary eye movements may: (a) fixations; and (b) saccades. When an eye is essentially focused on one point and not moving substantially, this is considered a fixation. A saccade movement, on the other hand, is a rapid eye movement between two fixations. In practice, jitters resulting from eye drift, tremors, and/or involuntary micro-saccades may result in a noisy gaze signal. A noisy gaze signal may, in turn, result in an inaccurate or unreliable measurement of eye movement when such a noisy gaze signal is analyzed for recovery of the observed eye motion.

In further accordance with example embodiments, a smoothing filter or a Kalman filter may be applied to a gaze signal to help reduce the noise introduced by such jitters. However, a filter may overly smooth the data during fast eye movements (saccades). To avoid over-smoothing the gaze signal, the filter may be re-initialized when large movements (e.g., saccades) are detected. This initialization may be accomplished as part of an analysis procedure that examines the signal for typical eye movement characteristics.

In accordance with example embodiments, eye-tracking techniques may be extended to account for the physical characteristics of the eye. In particular, a model of eye movement may be created based on physical characteristics such as: (a) the mass of the eye, (b) the mass of the eyelid, (c) a known range of speed for eye movements, and/or (d) known forces that can be exerted on the eye by e.g., the eyelid, among others. In further accordance with example embodiments, the eye model may be used to define certain physical characteristics of eye movement, which may be described in terms of eye movement parameters, such as: (a) a minimum and maximum eye movements during fixations (e.g., a variation between 1 and 4 degrees in angle); (b) a minimum and maximum eye movements during saccades (e.g., between 1 and 40 degrees in angle, with 15-20 degrees being typical); (c) a minimum and maximum duration of a saccade movement (e.g. durations between 30 ms and 120 ms); (d) a maximum frequency of occurrence of eye movements (e.g., the eye not moving more than ten times per second); (e) a minimum time duration between consecutive saccade movements (e.g., at least 100 ms separating two consecutive saccade movements; (f) a maximum duration for fixations (e.g., fixations lasting less than about 600 ms); (g) relationships between amplitude, duration, and/or velocity of saccades (e.g., a generally linear relationship between amplitude and duration or between amplitude and velocity), and/or other inconsistent eye movement results, such as translations of the eyeball out of the head or rotations too far into the head. Other rules and associated eye movement parameters may be defined as well.

In accordance with example embodiments, the physical characteristics for eye movement may be compared to a gaze signal in real-time, in order to detect when the gaze signal violates these rules. When the gaze signal violates one or more of the rules, this may be an indication that the gaze signal is erroneous and should not be used (e.g., due to interference from ambient light reflecting off the eye). Accordingly, when the gaze signal violates a physical characteristic for eye movement, an example eye-tracking system may take various actions, such as recalibrating the eye-tracking system and/or excluding measurement samples from that portion of the gaze signal until the gaze signal is again in compliance with the physical characteristic. For purposes of the discussion herein, these two possible cautionary actions—recalibration and sample exclusion—are referred to in a sort of conceptual short and herein as “turning off” the Kalman filter. It will be appreciated that the actual action is one that bypasses the introduction of errant or unreliable data from the gaze signal and/or avoids miscalibration of the Kalman filter in the face of errant or unreliable data.

In further accordance with example embodiments, an eye-tracking system may be implemented as part of, or in conjunction with, a wearable computing device having a head-mounted display (HMD). The HMD may include an eye-tracking device of an eye-tracking system. The HMD may also include a computing device that can receive a gaze signal and analyze it to recover eye movement measured by the eye-tracking device, as well to evaluate the gaze signal for compliance with the physical characteristics. Alternatively, the computing device may be located remotely from the HMD and receive the gaze signal via a communicative connection. For example, the computing device may be a server (or part of a server) in computer network.

In further accordance with example embodiments, a HMD may also include eyeglasses or goggles that can combine computer-generated images displayed on the eye-facing surfaces of lens elements with an actual field of view observable through the lens elements. The capability of presenting the combination of the actual, observed field-of-view (FOV) with the displayed, computer-generated images can be complemented or supplemented with various functions and applications, as well as with various forms of user input and sensory data from ancillary wearable computing components, to provide rich and varied experiences and utility for a user or wearer of the HMD.

One or more programs or applications running on the HMD may use a gaze signal, or measured eye movement derived from analysis of a gaze signal, as input to control or influence an operation in real time. For example, measured eye movement may be used to control movement of a visual cursor on display portion of the HMD. A noisy or erroneous gaze signal may have adverse effects on such a program or application.

In accordance with example embodiments, in response to determining that the gaze signal violates a physical characteristic for eye movement, the computing device may cause the HMD to display a notification message or otherwise notify a wearer of the HMD that the gaze signal is temporarily erroneous. Such a notification may serve as an alert as to why one or more features and/or functions of the HMD that use a gaze signal as input may not be functioning properly.

In further accordance with example embodiments, the notification or alert may take the form of a text message and/or video cue and/or audio cue presented in or at the HMD. For the example use-case in which a user is wearing the HMD, the notification or alert may signal to the user the occurrence of the adverse condition, and my further indicate to the user that eye-tracking input to one or more applications or programs running on the HMD may be unreliable and/or unusable, and may cause the one or more applications or programs to function improperly or exhibit undesirable behavior. For example, a user may thereby be alerted to stop or avoid using an eye-tracking-driven visual cursor.

Also in accordance with example embodiments, the HMD could be caused to cease or suspend operation of the one or more applications or programs that would otherwise exhibit undesirable behavior or function improperly. If and when the gaze signal again becomes reliable (e.g., below a noise level threshold), the notification could be removed, and any suspended operations resumed. Mitigation of a noisy gaze signal could be the result of specific actions (e.g., by a user), passage of a transient condition, or both.

2. Example Systems and Network

a. Example Wearable Computing System

In accordance with an example embodiment, a wearable computing system may comprise various components, including one or more processors, one or more forms of memory, one or more sensor devices, one or more I/O devices, one or more communication devices and interfaces, and a head-mountable display (HMD), all collectively arranged in a manner to make the system wearable by a user. The wearable computing system may also include machine-language logic (e.g., software, firmware, and/or hardware instructions) stored in one or another form of memory and executable by one or another processor of the system in order to implement one or more programs, tasks, applications, or the like. The wearable computing system may be configured in various form factors, including, without limitation, integrated in the HMD as a unified package, or distributed, with one or more elements integrated in the HMD and one or more others separately wearable (e.g., as a garment, in a garment pocket, as jewelry, etc.).

Although described above as a component of a wearable computing system, it is sometimes convenient to consider an HMD to be (or at least to represent) the wearable computing system. Accordingly, unless otherwise specified, the terms “wearable head-mountable display” (or “HMD”) or just “head-mountable display” (or “HMD”) will be used herein to refer to a wearable computing system, in either an integrated (unified package) form, a distributed (or partially distributed) form, or other wearable form.

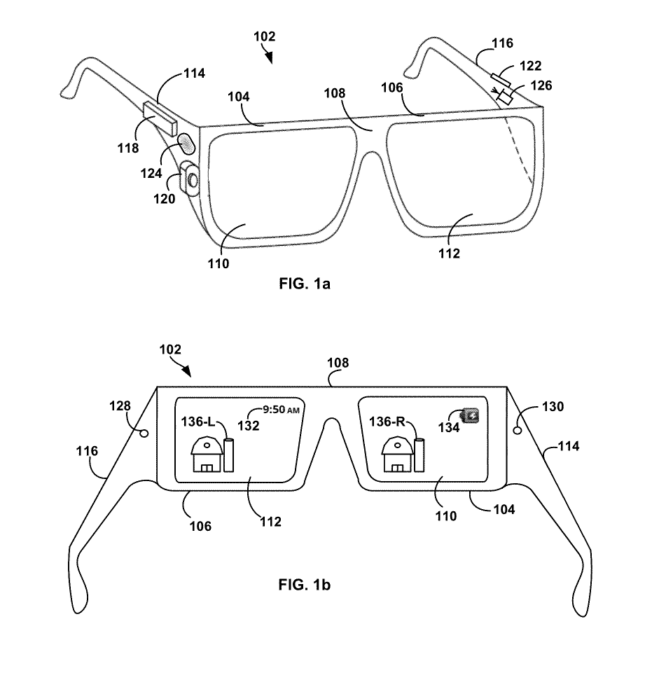

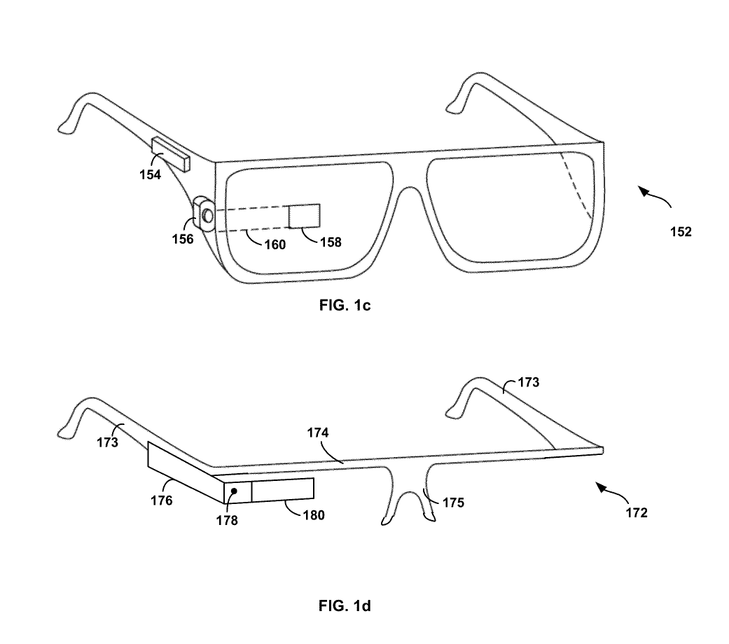

FIG. 1a illustrates an example wearable computing system 100 for receiving, transmitting, and displaying data. In accordance with an example embodiment, the wearable computing system 100 is depicted as an HMD taking the form of eyeglasses 102. However, it will be appreciated that other types of wearable computing devices could additionally or alternatively be used, including a monocular display configuration having only one lens-display element.

As illustrated in FIG. 1a, the eyeglasses 102 comprise frame elements including lens-frames 104 and 106 and a center frame support 108, lens elements 110 and 112, and extending side-arms 114 and 116. The center frame support 108 and the extending side-arms 114 and 116 are configured to secure the eyeglasses 102 to a user's face via a user's nose and ears, respectively. Each of the frame elements 104, 106, and 108 and the extending side-arms 114 and 116 may be formed of a solid structure of plastic or metal, or may be formed of a hollow structure of similar material so as to allow wiring and component interconnects to be internally routed through the eyeglasses 102. Each of the lens elements 110 and 112 may include a material on which an image or graphic can be displayed, either directly or by way of a reflecting surface. In addition, at least a portion of each lens elements 110 and 112 may be sufficiently transparent to allow a user to see through the lens element. These two features of the lens elements could be combined; for example, to provide an augmented reality or heads-up display where the projected image or graphic can be superimposed over or provided in conjunction with a real-world view as perceived by the user through the lens elements.

The extending side-arms 114 and 116 are each projections that extend away from the frame elements 104 and 106, respectively, and are positioned behind a user's ears to secure the eyeglasses 102 to the user. The extending side-arms 114 and 116 may further secure the eyeglasses 102 to the user by extending around a rear portion of the user's head. Additionally or alternatively, the wearable computing system 100 may be connected to or be integral to a head-mounted helmet structure. Other possibilities exist as well.

The wearable computing system 100 may also include an on-board computing system 118, a video camera 120, a sensor 122, a finger-operable touch pad 124, and a communication interface 126. The on-board computing system 118 is shown to be positioned on the extending side-arm 114 of the eyeglasses 102; however, the on-board computing system 118 may be provided on other parts of the eyeglasses 102. The on-board computing system 118 may include, for example, a one or more processors and one or more forms of memory. The on-board computing system 118 may be configured to receive and analyze data from the video camera 120, the sensor 122, the finger-operable touch pad 124, and the wireless communication interface 126 (and possibly from other sensory devices and/or user interfaces) and generate images for output to the lens elements 110 and 112.

The video camera 120 is shown to be positioned on the extending side-arm 114 of the eyeglasses 102; however, the video camera 120 may be provided on other parts of the eyeglasses 102. The video camera 120 may be configured to capture images at various resolutions or at different frame rates. Video cameras with a small form factor, such as those used in cell phones or webcams, for example, may be incorporated into an example of the wearable system 100. Although FIG. 1a illustrates one video camera 120, more video cameras may be used, and each may be configured to capture the same view, or to capture different views. For example, the video camera 120 may be forward facing to capture at least a portion of a real-world view perceived by the user. This forward facing image captured by the video camera 120 may then be used to generate an augmented reality where computer generated images appear to interact with the real-world view perceived by the user.

The sensor 122 may be used to measure and/or determine location, orientation, and motion information, for example. Although represented as a single component mounted on the extending side-arm 116 of the eyeglasses 102, the sensor 122 could in practice include more than one type of sensor device or element provided on one or more different parts of the eyeglasses 102.

By way of example and without limitation, the sensor 122 could include one or more of motion detectors (e.g., one or more gyroscopes and/or accelerometers), one or more magnetometers, and a location determination device (e.g., a GPS device). Gyroscopes, accelerometers, and magnetometers may be integrated into what is conventionally called an “inertial measurement unit” (IMU). An IMU may, in turn, be part of an “attitude heading reference system” (AHRS) that computes (e.g., using the on-board computing system 118) a pointing direction of the HMD from IMU sensor data, possibly together with location information (e.g., from a GPS device). Accordingly, the sensor 122 could include or be part of an AHRS. Other sensing devices or elements may be included within the sensor 122 and other sensing functions may be performed by the sensor 122.

The finger-operable touch pad 124, shown mounted on the extending side-arm 114 of the eyeglasses 102, may be used by a user to input commands. However, the finger-operable touch pad 124 may be positioned on other parts of the eyeglasses 102. Also, more than one finger-operable touch pad may be present on the eyeglasses 102. The finger-operable touch pad 124 may be used by a user to input commands. The finger-operable touch pad 124 may sense at least one of a position and a movement of a finger via capacitive sensing, resistance sensing, or a surface acoustic wave process, among other possibilities. The finger-operable touch pad 124 may be capable of sensing finger movement in a direction parallel to the pad surface, in a direction normal to the pad surface, or both, and may also be capable of sensing a level of pressure applied. The finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge of the finger-operable touch pad 124. Although not shown in FIG. 1a, the eyeglasses 102 could include one more additional finger-operable touch pads, for example attached to the extending side-arm 316, which could be operated independently of the finger-operable touch pad 124 to provide a duplicate and/or different function.

The communication interface 126 could include an antenna and transceiver device for support of wireline and/or wireless communications between the wearable computing system 100 and a remote device or communication network. For instance, the communication interface 126 could support wireless communications with any or all of 3G and/or 4G cellular radio technologies (e.g., CDMA, EVDO, GSM, UMTS, LTE, WiMAX), as well as wireless local or personal area network technologies such as a Bluetooth, Zigbee, and WiFi (e.g., 802.11a, 802.11b, 802.11g). Other types of wireless access technologies could be supported as well. The communication interface 126 could enable communications between the wearable computing system 100 and one or more end devices, such as another wireless communication device (e.g., a cellular phone or another wearable computing device), a user at a computer in a communication network, or a server or server system in a communication network. The communication interface 126 could also support wired access communications with Ethernet or USB connections, for example.

FIG. 1b illustrates another view of the wearable computing system 100 of FIG. 1a. As shown in FIG. 1b, the lens elements 110 and 112 may act as display elements. In this regard, the eyeglasses 102 may include a first projector 128 coupled to an inside surface of the extending side-arm 116 and configured to project a display image 132 onto an inside surface of the lens element 112. Additionally or alternatively, a second projector 130 may be coupled to an inside surface of the extending side-arm 114 and configured to project a display image 134 onto an inside surface of the lens element 110.

The lens elements 110 and 112 may act as a combiner in a light projection system and may include a coating that reflects the light projected onto them from the projectors 128 and 130. Alternatively, the projectors 128 and 130 could be scanning laser devices that interact directly with the user's retinas. The projectors 128 and 130 could function to project one or more still and/or video images generated by one or more display elements (not shown). The projected images could thereby be caused to appear within the field of view of the lens elements 110 and/or 112 via the coating and/or by direct scanning.

A forward viewing field may be seen concurrently through lens elements 110 and 112 with projected or displayed images (such as display images 132 and 134). This is represented in FIG. 1b by the field of view (FOV) object 136-L in the left lens element 112 and the same FOV object 136-R in the right lens element 110. The combination of displayed images and real objects observed in the FOV may be one aspect of augmented reality, referenced above. In addition, images could be generated for the right and left lens elements produce a virtual three-dimensional space when right and left images are synthesized together by a wearer of the HMD. Virtual objects could then be made to appear to be located in and occupy the actual three-dimensional space viewed transparently through the lenses.

Although not explicitly shown in the figures, the HMD could include an eye-tracking system or a portion of such a system. In an example embodiment, the HMD could include inward- or rearward-facing (i.e., eye-facing) light source(s) and/or camera(s) to facilitate eye-tracking functions. For example, an HMD may include inward-facing light sources, such as an LED(s), at generally known location(s) with respect to one another and/or with respect to an eye under observation. The inward-facing camera may therefore capture images that include the reflections of the light source(s) off the eye, or other observable eye-movement information that may form eye-tracking data or an eye-tracking signal. The eye-tracking data or eye-tracking signal may then be analyzed to determine the position and movement of the eye (or eyes) as seen by the eye-tracking system or device. Eye movement may also be reference to other components of the HMD, such as positions in a plane of the lens elements 110 and/or 112, or the displayable regions thereof. Other forms of eye tracking could be used as well. Operation of an example eye-tracking device is described in more detail below.

In alternative embodiments, other types of display elements may also be used. For example, lens elements 110, 112 may include: a transparent or semi-transparent matrix display, such as an electroluminescent display or a liquid crystal display; one or more waveguides for delivering an image to the user's eyes; and/or other optical elements capable of delivering an in focus near-to-eye image to the user. A corresponding display driver may be disposed within the frame elements 104 and 106 for driving such a matrix display. Alternatively or additionally, a scanning laser device, such as low-power laser or LED source and accompanying scanning system, can draw a raster display directly onto the retina of one or more of the user's eyes. The user can then perceive the raster display based on the light reaching the retina.

Although not shown in FIGS. 1a and 1b, the wearable system 100 can also include one or more components for audio output. For example, wearable computing system 100 can be equipped with speaker(s), earphone(s), and/or earphone jack(s). Other possibilities exist as well.

While the wearable computing system 100 of the example embodiment illustrated in FIGS. 1a and 1b is configured as a unified package, integrated in the HMD component, other configurations are possible as well. For example, although not explicitly shown in FIGS. 1a and 1b, the wearable computing system 100 could be implemented in a distributed architecture in which all or part of the on-board computing system 118 is configured remotely from the eyeglasses 102. For example, some or all of the on-board computing system 118 could be made wearable in or on clothing as an accessory, such as in a garment pocket or on a belt clip. Similarly, other components depicted in FIGS. 1a and/or 1b as integrated in the eyeglasses 102 could also be configured remotely from the HMD component. In such a distributed architecture, certain components might still be integrated in HMD component. For instance, one or more sensors (e.g., a magnetometer, gyroscope, etc.) could be integrated in eyeglasses 102.

In an example distributed configuration, the HMD component (including other integrated components) could communicate with remote components via the communication interface 126 (or via a dedicated connection, distinct from the communication interface 126). By way of example, a wired (e.g. USB or Ethernet) or wireless (e.g., WiFi or Bluetooth) connection could support communications between a remote computing system and a HMD component. Additionally, such a communication link could be implemented between a HMD component and other remote devices, such as a laptop computer or a mobile telephone, for instance.

FIG. 1c illustrates another wearable computing system according to an example embodiment, which takes the form of a HMD 152. The HMD 152 may include frame elements and side-arms such as those described with respect to FIGS. 1a and 1b. The HMD 152 may additionally include an on-board computing system 154 and a video camera 156, such as those described with respect to FIGS. 1a and 1b. The video camera 156 is shown mounted on a frame of the HMD 152. However, the video camera 156 may be mounted at other positions as well.

As shown in FIG. 1c, the HMD 152 may include a single display 158 which may be coupled to the device. The display 158 may be formed on one of the lens elements of the HMD 152, such as a lens element described with respect to FIGS. 1a and 1b, and may be configured to overlay computer-generated graphics in the user's view of the physical world. The display 158 is shown to be provided in a center of a lens of the HMD 152, however, the display 158 may be provided in other positions. The display 158 is controllable via the computing system 154 that is coupled to the display 158 via an optical waveguide 160.

FIG. 1d illustrates another wearable computing system according to an example embodiment, which takes the form of a HMD 172. The HMD 172 may include side-arms 173, a center frame support 174, and a bridge portion with nosepiece 175. In the example shown in FIG. 1d, the center frame support 174 connects the side-arms 173. The HMD 172 does not include lens-frames containing lens elements. The HMD 172 may additionally include an on-board computing system 176 and a video camera 178, such as those described with respect to FIGS. 1a and 1b.

The HMD 172 may include a single lens element 180 that may be coupled to one of the side-arms 173 or the center frame support 174. The lens element 180 may include a display such as the display described with reference to FIGS. 1a and 1b, and may be configured to overlay computer-generated graphics upon the user's view of the physical world. In one example, the single lens element 180 may be coupled to the inner side (i.e., the side exposed to a portion of a user's head when worn by the user) of the extending side-arm 173. The single lens element 180 may be positioned in front of or proximate to a user's eye when the HMD 172 is worn by a user. For example, the single lens element 180 may be positioned below the center frame support 174, as shown in FIG. 1 d.

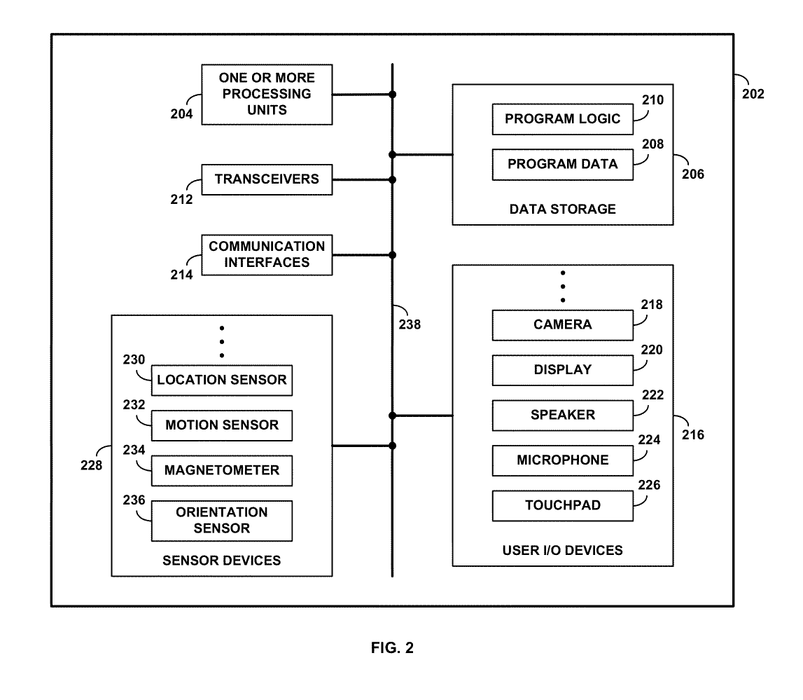

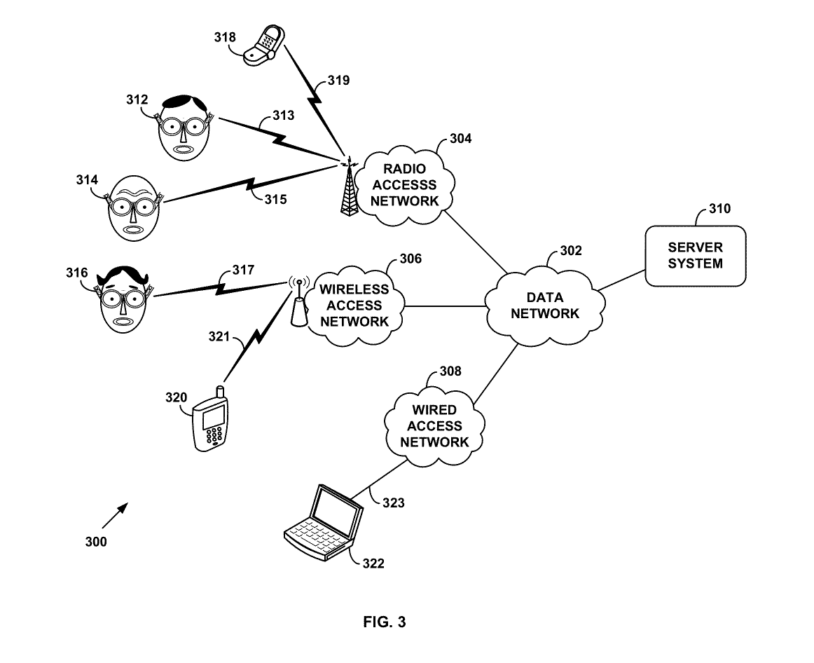

FIG. 2 is a block diagram depicting functional components of an example wearable computing system 202 in accordance with an example embodiment. As shown in FIG. 2, the example wearable computing system 202 includes one or more processing units 204, data storage 206, transceivers 212, communication interfaces 214, user input/output (I/O) devices 216, and sensor devices 228, all of which may be coupled together by a system bus 238 or other communicative interconnection means. These components may be arranged to support operation in accordance with an example embodiment of a wearable computing system, such as system 100 shown in FIGS. 1a and 1b, or other an HMD.

The one or more processing units 204 could include one or more general-purpose processors (e.g., INTEL microprocessors) and/or one or more special-purpose processors (e.g., dedicated digital signal processor, application specific integrated circuit, etc.). In turn, the data storage 206 could include one or more volatile and/or non-volatile storage components, such as magnetic or optical memory or disk storage. Data storage 206 can be integrated in whole or in part with processing unit 204, as cache memory or registers for instance. As further shown, data storage 206 is equipped to hold program logic 208 and program data 210.

Program logic 208 could include machine language instructions (e.g., software code, firmware code, etc.) that define routines executable by the one or more processing units 204 to carry out various functions described herein. Program data 210 could contain data used or manipulated by one or more applications or programs executable by the one or more processors. Such data can include, among other forms of data, program-specific data, user data, input/output data, sensor data, or other data and information received, stored, retrieved, transmitted, analyzed, or modified in the course of execution of one or more programs or applications.

The transceivers 212 and communication interfaces 214 may be configured to support communication between the wearable computing system 202 and one or more end devices, such as another wireless communication device (e.g., a cellular phone or another wearable computing device), a user at a computer in a communication network, or a server or server system in a communication network. The transceivers 212 may be coupled with one or more antennas to enable wireless communications, for example, as describe above for the wireless communication interface 126 shown in FIG. 1a. The transceivers 212 may also be coupled with one or more and wireline connectors for wireline communications such as Ethernet or USB. The transceivers 212 and communication interfaces 214 could also be used support communications within a distributed-architecture in which various components of the wearable computing system 202 are located remotely from one another. In this sense, the system bus 238 could include elements and/or segments that support communication between such distributed components.

As shown, the user I/O devices 216 include a camera 218, a display 220, a speaker 222, a microphone 224, and a touchpad 226. The camera 218 could correspond to the video camera 120 described in the discussion of FIG. 1a above. Similarly, the display 220 could correspond to an image processing and display system for making images viewable to a user (wearer) of an HMD. The display 220 could include, among other elements, the first and second projectors 128 and 130 coupled with lens elements 112 and 110, respectively, for generating image displays as described above for FIG. 1b. The touchpad 226 could correspond to the finger-operable touch pad 124, as described for FIG. 1a. The speaker 422 and microphone 224 could similarly correspond to components referenced in the discussion above of FIGS. 1 and 1b. Each of the user I/O devices 216 could also include a device controller and stored, executable logic instructions, as well as an interface for communication via the system bus 238.

The sensor devices 228, which could correspond to the sensor 122 described above for FIG. 1a, include a location sensor 230, a motion sensor 232, one or more magnetometers 234, and an orientation sensor 236. The location sensor 230 could correspond to a Global Positioning System (GPS) device, or other location-determination device (e.g. mobile phone system triangulation device, etc.). The motion sensor 232 could correspond to one or more accelerometers and/or one or more gyroscopes. A typical configuration may include three accelerometers oriented along three mutually orthogonal axes, for example. A similar configuration of three magnetometers can also be used.

The orientation sensor 236 could include or be part of an AHRS for providing theodolite-like functionality for determining an angular orientation of a reference pointing direction of the HMD with respect to a local terrestrial coordinate system. For instance, the orientation sensor could determine an altitude angle with respect to horizontal and an azimuth angle with respect to a reference directions, such as geographic (or geodetic) North, of a forward pointing direction of the HMD. Other angles and coordinate systems could be used as well for determining orientation.

The magnetometer 234 (or magnetometers) could be used to determine the strength and direction of the Earth's magnetic (geomagnetic) field as measured at a current location of the HMD.

Each of the sensor devices 228 could also include a device controller and stored, executable logic instructions, as well as an interface for communication via the system bus 238.

It will be appreciated that there can be numerous specific implementations of a wearable computing system or HMD, such as the wearable computing system 202 illustrated in FIG. 2. Further, one of skill in the art would understand how to devise and build such an implementation.

b. Example Network

In an example embodiment, an HMD can support communications with a network and with devices in or communicatively connected with a network. Such communications can include exchange of information between the HMD and another device, such as another connected HMD, a mobile computing device (e.g., mobile phone or smart phone), or a server. Information exchange can support or be part of services and/or applications, including, without limitation, uploading and/or downloading content (e.g., music, video, etc.), and client-server communications, among others.

FIG. 3 illustrates one view of a network 300 in which one or more HMDs could engage in communications. As depicted, the network 300 includes a data network 302 that is connected to each of a radio access network (RAN) 304, a wireless access network 306, and a wired access network 308. The data network 302 could represent the one or more interconnected communication networks, such as or including the Internet. The radio access network 304 could represent a service provider's cellular radio network supporting, for instance, 3G and/or 4G cellular radio technologies (e.g., CDMA, EVDO, GSM, UMTS, LTE, WiMAX). The wireless access network 306 could represent a residential or hot-spot wireless area network supporting, such as, Bluetooth, ZigBee, and WiFi (e.g., 802.11a, 802.11b, 802.11g). The wired access network 308 could represent a residential or commercial local area network supporting, for instance, Ethernet.

The network 300 also includes a server system 310 connected to the data network 302. The server system 310 could represent a website or other network-based facility for providing one or another type of service to users. For instance, in accordance with an example embodiment, the server system 310 could host an online social networking service or website. As another example, the server system 310 could provide a network-based information search service. As still a further example, the server system 310 could receive eye-tracking data from a HMD, and returned analyzed results to the HMD.

FIG. 3 also shows various end-user and/or client devices connected to the network 300 via one of the three access networks. By way of example, an HMD 312 is connected to the RAN 304 via an air interface 313 (e.g., a 3G or 4G technology), and an HMD 314 is connected to the RAN 304 via an air interface 315 (e.g., a 3G or 4G technology). Also by way of example, an HMD 316 is connected to the wireless access network 306 via an air interface 317 (e.g., a WiFi technology). In addition and also by way of example, a mobile phone 318 is shown connected to the RAN 304 via an air interface 319, a smart phone 320 is shown connected to the wireless access network 306 via an air interface 321, and a laptop computer 322 is shown connected to the wired access network 308 via a wired interface 323. Each of the end-user devices could communicate with one or another network-connected device via its respective connection with the network. It could be possible as well for some of these end-user devices to communicate directly with each other (or other end-user devices not shown).

Each of the HMDs 312, 314, and 316 is depicted as being worn by different user (each user being represented by a cartoon face) in order to signify possible user-related variables, circumstances, and applications that may be associated with each HMD. For instance, the HMD 312 could at one time upload content to an online social networking service, whereas the HMD 314 could at the same or another time send a request to a network-based information search service. Users could interact with each other and/or with the network via their respective HMDs. Other examples are possible as well. For the purposes of most of the discussion herein it is usually sufficient to reference only an HMD without referencing the user (or wearer) the HMD. Explicit reference to or discussion of a user (or wearer) of an HMD will be made as necessary.

c. Example Server System

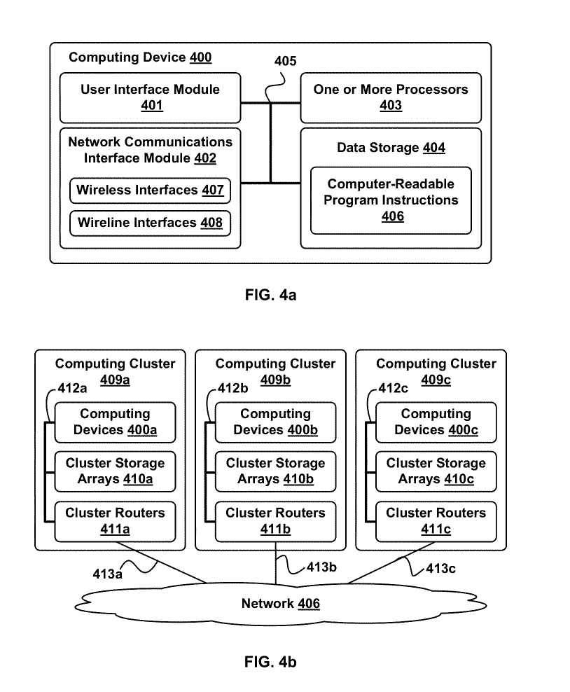

A network server, such as the server system 310 in FIG. 3, could take various forms and be implemented in one or more different ways. FIGS. 4a and 4b illustrate two example embodiments of a server system: an integrated system including a representative computing device (FIG. 4a), and a distributed system (FIG. 4b) including multiple representative computing devices, as well as additional system elements, communicatively connected together.

FIG. 4a is a block diagram of a computing device 400 in accordance with an example embodiment. The computing device 400 can include a user interface module 401, a network-communication interface module 402, one or more processors 403, and data storage 404, all of which can be linked together via a system bus, network, or other connection mechanism 405.

The user interface module 401 can be operable to send data to and/or receive data from external user input/output devices. For example, the user interface module 401 can be configured to send/receive data to/from user input devices such as a keyboard, a keypad, a touch screen, a computer mouse, a track ball, a joystick, and/or other similar devices, now known or later developed. The user interface module 401 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, now known or later developed. The user interface module 401 can also be configured to generate audible output(s), such as a speaker, speaker jack, audio output port, audio output device, earphones, and/or other similar devices, now known or later developed.

The network-communications interface module 402 can include one or more wireless interfaces 407 and/or wireline interfaces 408 that are configurable to communicate via a network, such as the network 302 shown in FIG. 3. The wireless interfaces 407 can include one or more wireless transceivers, such as a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other types of wireless transceivers configurable to communicate via a wireless network. The wireline interfaces 408 can include one or more wireline transceivers, such as an Ethernet transceiver, a Universal Serial Bus (USB) transceiver, or similar transceiver configurable to communicate via a wire, a twisted pair of wires, a coaxial cable, an optical link, a fiber-optic link, or other physical connection to a wireline network.

In some embodiments, the network communications interface module 402 can be configured to provide reliable, secured, compressed, and/or authenticated communications. For each communication described herein, information for ensuring reliable communications (e.g., guaranteed message delivery) can be provided, perhaps as part of a message header and/or footer (e.g., packet/message sequencing information, encapsulation header(s) and/or footer(s), size/time information, and transmission verification information such as cyclic redundancy check (CRC) and/or parity check values). Communications can be compressed and decompressed using one or more compression and/or decompression algorithms and/or protocols such as, but not limited to, one or more lossless data compression algorithms and/or one or more lossy data compression algorithms. Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

The one or more processors 403 can include one or more general purpose processors and/or one or more special purpose processors (e.g., digital signal processors, application specific integrated circuits, etc.). The one or more processors 403 can be configured to execute computer-readable program instructions 406 that are contained in the data storage 404 and/or other instructions as described herein.

The data storage 404 can include one or more computer-readable storage media that can be read or accessed by at least one of the processors 403. The one or more computer-readable storage media can include volatile and/or non-volatile storage components, such as optical, magnetic, organic or other memory or disc storage, which can be integrated in whole or in part with at least one of the one or more processors 403. In some embodiments, the data storage 404 can be implemented using a single physical device (e.g., one optical, magnetic, organic or other memory or disc storage unit), while in other embodiments, the data storage 404 can be implemented using two or more physical devices.

Computer-readable storage media associated with data storage 404 and/or other computer-readable media described herein can also include non-transitory computer-readable media such as computer-readable media that stores data for short periods of time like register memory, processor cache, and random access memory (RAM). Computer-readable storage media associated with data storage 404 and/or other computer-readable media described herein can also include non-transitory computer readable media that stores program code and/or data for longer periods of time, such as secondary or persistent long term storage, like read only memory (ROM), optical or magnetic disks, compact-disc read only memory (CD-ROM), for example. Computer-readable storage media associated with data storage 404 and/or other computer-readable media described herein can also be any other volatile or non-volatile storage systems. Computer-readable storage media associated with data storage 404 and/or other computer-readable media described herein can be considered computer readable storage media for example, or a tangible storage device.

The data storage 404 can include computer-readable program instructions 406 and perhaps additional data. In some embodiments, the data storage 404 can additionally include storage required to perform at least part of the herein-described techniques, methods, and/or at least part of the functionality of the herein-described devices and networks.

FIG. 4b depicts a network 406 with computing clusters 409a, 409b, and 409c in accordance with an example embodiment. In FIG. 4b, functions of a network server, such as the server system 310 in FIG. 3, can be distributed among three computing clusters 409a, 409b, and 408c. The computing cluster 409a can include one or more computing devices 400a, cluster storage arrays 410a, and cluster routers 411a, connected together by local cluster network 412a. Similarly, computing cluster 409b can include one or more computing devices 400b, cluster storage arrays 410b, and cluster routers 411b, connected together by local cluster network 412b. Likewise, computing cluster 409c can include one or more computing devices 400c, cluster storage arrays 410c, and cluster routers 411c, connected together by a local cluster network 412c.

In some embodiments, each of computing clusters 409a, 409b, and 409c can have an equal number of computing devices, an equal number of cluster storage arrays, and an equal number of cluster routers. In other embodiments, however, some or all of computing clusters 409a, 409b, and 409c can have different numbers of computing devices, different numbers of cluster storage arrays, and/or different numbers of cluster routers. The number of computing devices, cluster storage arrays, and cluster routers in each computing cluster can depend on the computing task or tasks assigned to each computing cluster.

Cluster storage arrays 410a, 410b, and 410c of computing clusters 409a, 409b, and 409c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

The cluster routers 411a, 411b, and 411c in the computing clusters 409a, 409b, and 409c can include networking equipment configured to provide internal and external communications for the computing clusters. For example, the cluster routers 411a in the computing cluster 409a can include one or more internet switching and/or routing devices configured to provide (i) local area network communications between the computing devices 400a and the cluster storage arrays 401a via the local cluster network 412a, and/or (ii) wide area network communications between the computing cluster 409a and the computing clusters 409b and 409c via the wide area network connection 413a to the network 406. The cluster routers 411b and 411c can include network equipment similar to the cluster routers 411a, and the cluster routers 411b and 411c can perform similar networking functions for the computing clusters 409b and 409b that the cluster routers 411a perform for the computing cluster 409a.

3. Evaluation of a Gaze Signal Based on a Physical Model of Eye Movement

In accordance with example embodiments, eye tracking may be determined and used in real time by a wearable computing device, such as a HMD, to provide input to one or more applications or programs on the HMD. For example, an application may use eye gaze direction and/or eye motion to control a visual cursor on a display. Eye tracking may also provide input to one or more applications or programs running on a computing device, such as a server, that is communicatively connected with the HMD but external to it.

a. Eye Tracking Operation

Eye tracking may include one or more detection and/or measurement operations to obtain eye-tracking data that contains information indicative of eye position, eye movement, and other observable features and characteristics of one or more eyes. Eye tracking may also include one or more analysis operations to analyze the eye-tracking data in order to determine the eye position, eye movement, and the other observable features and characteristics of one or more eyes in a form suitable for input by an application or for interpretation by a user, for example.

Detection and/or measurement may be carried out by an eye-tracking device, such as a video camera, configured to observe and/or measure position, movement, and possibly other characteristics of the one or more eyes. Analysis of the eye-tracking data may be carried out by one or more processors of a HMD, by a server (or other computing device or platform) external to the HMD that receives the eye-tracking data from the HMD via a communicative connection, or both working together in a distributed manner, for example.

Eye-tracking data may include an eye-tracking or gaze signal, corresponding to output of an eye-tracking device, such as a video stream from an eye-tracking video camera. As such, the eye-tracking signal represents an encoded form of the observations of the one or more eyes by the eye-tracking device. For example, the gaze signal could be a digitized encoding of an analog measurement signal. It will be appreciated that other forms of gaze signal are possible as well, including known types of streaming video. The eye-tracking data may include additional information, such as time stamps, calibration scales, parameters, or other ancillary information used in analysis of the eye-tracking data.

In accordance with example embodiments, the observable quantities obtained by the eye-tracking device and output as the eye-tracking signal may be used to determine dynamic characteristics of eye movement, such as ranges of angular motions and speed of angular motion. Acquisition of such eye-movement characteristics from a large sample of different people may provide a basis for determining frequency (or probability) distributions of the dynamic characteristics. In addition, measurements of such physical characteristics as mass of the eye, mass of the eyelid, and size dimensions of various components of the eye, for a large sample of different people may similarly provide a basis for determining frequency (or probability) distributions of the these physical characteristics. Taken together, the various distributions may be used to derive or calculate a model of eye movement including, for example, known or calculated speed and/or amplitude ranges for eye movements, known or calculated forces that can be exerted on the eye by the eyelid. The model may then form bases for evaluation subsequent observations of eye motion.

More particularly, dynamic properties such as eye movement and position present in the eye-tracking signal, and may be determined via temporal analysis of the eye-tracking data. Illustratively, such dynamic properties may include details relating to fixations and saccades. Still further, details relating to fixations and saccades may include, for example, amplitude, direction, duration, velocity, among others. Once a model is developed, it can be used to evaluation the reliability of run-time measurements of eye motion. In particular, a gaze signal that yields motion beyond the limits of what the model specifies as physically realistic may be deemed unreliable.

Generally, an eye-tracking video camera may capture video frames, each containing an image in the form of a two-dimensional pixel array. Each image may thus include a pixel-rendering of an eye. Physical characteristics and movement of the eye may be determined from one or more of such images. For example, movement of the may be determined by analyzing how a feature of the eye, such as the pupil, changes position in the image plane across successive video frames. By correlating such geometric parameters as pixel plane size and distance of the video camera from the observed eye, changes in pixel location across video frames may be converted to angular movement (position and rate of change of position) of the eye.

In a related manner, by positioning one or more known, controlled light sources, such as an LED (or LEDs), at a calibrated location (or locations) with respect to one or more eyes under observation, and then by capturing video images of reflections of the light source off the one or more eyes, successive video frames may capture movement of the reflections in the image plane as the one or more eyes move. With the relative geometry of the controlled light source and the one or more eyes known, the observed movement of the reflections in the image plane may be translated into movement of the one or more eyes. As mentioned above, reflections of a known, controlled light source are referred to as controlled glints.

In further accordance with example embodiments, eye tracking may use both eye-feature observations and controlled glints to determine eye movement and position, possibly as well as other properties and characteristics of one or more eyes.

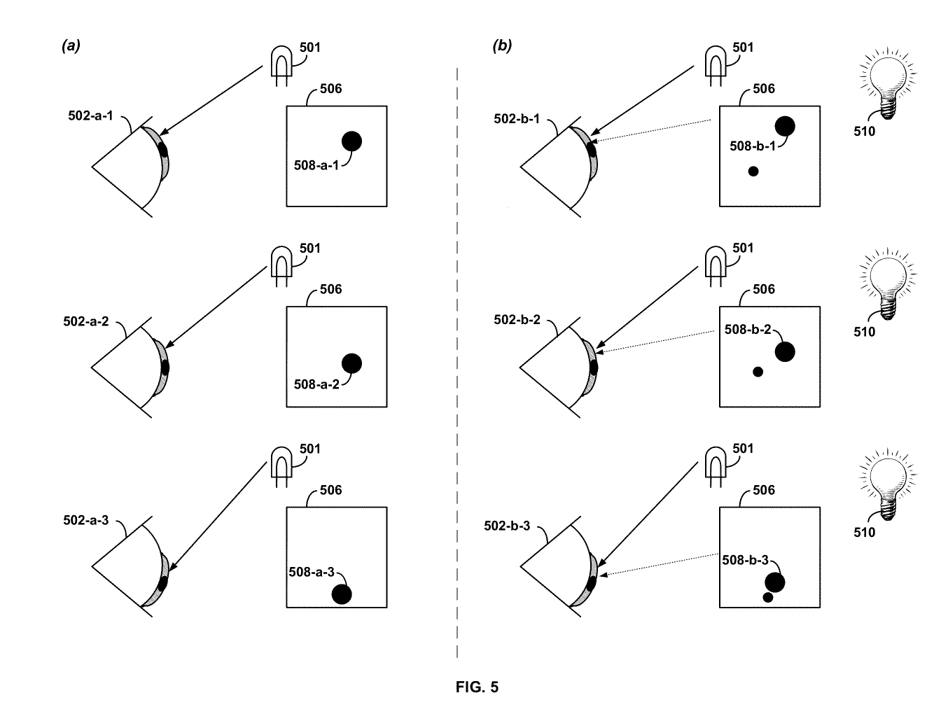

FIG. 5 is a conceptual illustration of eye tracking using controlled glints, according to example embodiments. The left-hand side of FIG. 5 (labeled “(a)”) shows a schematic representation of an eye in three different angular orientations with respect to an LED 501 at a fixed location relative to the eye: eye 502-a-1 (top left) is gazing slightly upward; eye 502-a-2 (top middle) is gazing horizontally; and eye 502-a-3 (bottom left) is gazing slightly downward. For each orientation, the LED 501 is (at a fixed location relative to the eye) creates a controlled glint off the eye; the light from the LED 501 is represented respectively as solid arrows from the LED 501 toward the eye. For each orientation of the eye, the glint will be detected at a different location on the eye. Each different location on the eye may be represented conceptually as detection at a different location in a pixel array 506 that could be part of an eye-tracking camera, for example. This is illustrated to the right of the eye; in each image, a black dot represents a controlled glint detected for the corresponding eye orientation: detected glint 508-a-1 for the top orientation; detected glint 508-a-2 for the middle orientation; and detected glint 508-a-3 for the bottom orientation. It will be appreciated that the respective locations of the detected glint in the pixel-array illustrate that different orientations of the eye relative to the LED 501 result in detection by different pixels. However, the particular locations shown are not necessarily intended to represent a precise or true rendering of where in the LED 501 the glints would actually be detected, but rather illustrate the concept of correlating eye movement with glint movement in the image plane. Further, in accordance with example embodiments, the locations in the pixel array may be analytically mapped to eye orientations.

In accordance with example embodiments, each image 506 could correspond to a frame of video signal. The eye-tracking signal could then be considered as encoding pixel positions and values for each frame, including the pixel positions and values associated with the respectively detected glints 508-a-1, 508-a-2, and 508-a-3 of the current illustrative example. Analysis of the eye-tracking signal could then include determining the pixel positions and values associated with the respectively detected glints, and reconstructing the angular orientation of the eye for each image. Frame-by-frame image data could also be used to measure angular velocity of the eye (e.g., saccades). It will be appreciated that this description of data acquisition and analysis is simplified for purposes of the present illustration, and that there may be other steps in practice.

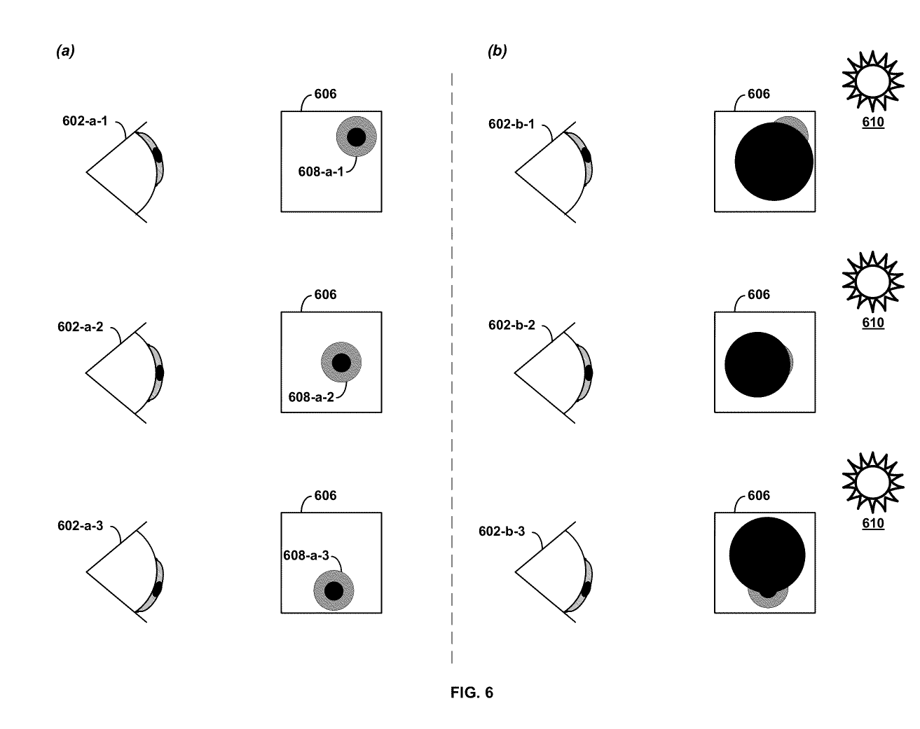

FIG. 6 is a conceptual illustration of eye tracking using images of the eye, according to example embodiments. The depiction in FIG. 6 is similar to that of FIG. 5, but with figure elements relabeled with numbers referencing 600. The left-hand side of FIG. 6 (labeled “(a)”) again shows a schematic representation of an eye in three different angular orientations at a fixed location relative to the eye: eye 602-a-1 (top left) is gazing slightly upward; eye 602-a-2 (top middle) is gazing horizontally; and eye 602-a-3 (bottom left) is gazing slightly downward. For this example technique, the eye-tracking signal captures an image of the iris and pupil of the eye. The images of the eye at angular positions 602-1, 602-2, and 602-3 are captured in the image plane 606, and appear at positions 602-a-1, 602-a-2, and 602-a-1, respectively.

In accordance with example embodiments, analysis of the eye-tracking signal includes one or more algorithms for recognizing the iris and/or pupil in each image, and analytically reconstruction eye position and motion (e.g., saccades) from the change in the position of the iris and/or pupil across successive image frame. In the current example, the three pixel-array images show the movement of the iris/pupil across the image plane.

Information derived from an eye-tracking camera may take the form of an eye-tracking signal, or gaze signal, and may be used as input to one or another process or program. By way of example, the gaze signal could be provided as a stream of digitized data.

In practice, jitters resulting from eye drift, tremors, and/or involuntary micro-saccades may result in a noisy gaze signal. A noisy gaze signal may result in an inaccurate or unreliable measurement of eye movement when such a noisy gaze signal is analyzed for recovery of the observed eye motion.

A smoothing filter and/or a Kalman filter may be applied to a gaze signal to help reduce the noise introduced by such jitters. However, a filter may overly smooth the data during fast eye movements (saccades). To avoid over-smoothing the gaze signal, the filter may be re-initialized when large movements (e.g., saccades) are detected. This initialization may be accomplished as part of an analysis procedure that examines the signal for typical eye movement characteristics.

Turning off a filter due to detecting large eye movements presumes that the detected eye movements are accurate or reliable. However, in some situations, a large eye movement may be detected from an unreliable gaze signal. For example, the eye movement may not be physically reasonable or normal. In such cases, the eye movement should be evaluated to determine if the gaze signal itself may be erroneous or unreliable.

b. Determination of an Erroneous or Unreliable Eye-Tracking Signal

Various causes of an erroneous or unreliable eye-tracking signal may arise in practice. One example is excessive ambient light, which may be illustrated for eye tracking based on controlled glints. More particularly, a device may detect and/or measure other observable quantities besides known features of the one or more eyes and/or controlled glints from the one or more eyes. Some of the other observable quantities may not necessarily be helpful to the process of eye tracking. The presence of ambient light may be detected directly by an eye-tracking video camera, or may be detected as spurious reflections off the one or more eyes. As a consequence, the eye-tracking signal may include contributions from ambient light. In the context of analysis of the eye-tracking signal for eye movement and position (possibly as well as other observable characteristics and properties of the one or more eyes), ambient light may manifest as interference, and may introduce a level of uncertainty in the analytical determinations.

It may happen from time to time that a level of interference from ambient light may be sufficiently high so as to cause the eye-tracking data, or the analysis of the eye-tracking data, to be statistically unreliable. When this situation occurs, the use of eye-tracking as input to one or more applications may yield undesirable or erroneous behavior of those one or more applications.

An example of the effect of ambient light interference is illustrated in the right-hand side of FIG. 5 (and labeled “(b)”). In this example, the orientations of the eye, relabeled eye 502-b-1, 502-b-2, and 502-b-3, are the same as those described above for the left-hand side (a) of FIG. 5. Similarly, the illuminating LED 501, and the pixel-array image 506 are also the same as the left-hand side (a) of FIG. 5. However, an ambient source represented by light bulb 510 is now present, by way of example. Ambient light impinging on the eye are represented as a dashed arrow pointing toward the eye in each orientation.

In this example of ambient-light interference, the reflected glints, relabeled glints 508-b-1, 508-b-2, and 508-b-3, appear at the same positions in the respective pixel-array images. However, there is now a spurious feature (unlabeled) in each image generated by the ambient light from the bulb 510. Such features could mimic legitimate glints, and reduce the reliability of an analysis which reconstructs eye movement and position from pixel location and pixel value of glints. The degree to which such spurious features effect the reliability of reconstructing eye-tracking from controlled glints may be depend on if and how they may be distinguished from legitimate controlled glints.

As an example, if spurious features appear as bright as glints in an image, then it may not be possible to distinguish controlled glints from spurious features. In this case, ambient-light interference may result in an erroneous and/or unreliable eye-tracking.

Another example of the effect of ambient light interference illustrated in the right-hand side of FIG. 6 (and labeled “(b)”) shows ambient light interference from a strong light source, represented by Sun 610. In this example, the ambient light effectively washes out the images, so that no pupil/iris features can even be identified. As with the example illustrated in FIG. 5, an erroneous and/or unreliable eye-tracking signal may result.

Although not necessarily illustrated in FIGS. 5 and 6, there could be other causes of an erroneous and/or unreliable eye-tracking signal. For example, vibration of a HMD worn by a user—for example while the user is riding a subway—could result in relative movement between an eye-tracking device and the user's eyes that is not due to saccades or other natural eye movement. If such relative movement is excessive, the eye-tracking signal that captures the movement could become unreliable. Other sources or causes of erroneous and/or unreliable eye-tracking signals are possible as well.

In accordance with example embodiments, an eye-tracking or gaze signal may be analytically evaluated by comparing the eye movement derived from the signal with a model of eye movement based on physical characteristics of the eye, as described generally above, for example. In particular, the physical characteristics of the eye may be used to set values of parameters of eye movement. The parameters may set ranges or thresholds on measured variables derived from the actual eye-tracking signal, thereby defining rules of eye movement. Illustrativley, the rules of eye movement may include, for example, (a) a minimum and maximum eye movements during fixations (e.g., a variation between 1 and 4 degrees in angle), (b) a minimum and maximum eye movements during saccades (e.g., between 1 and 40 degrees in angle, with 15-20 degrees being typical), (c) minimum and maximum durations of a saccade movement (e.g. durations between about 30 ms and 120 ms), (d) a maximum frequency of occurrence of eye movements between fixations (e.g., the eye not moving more than ten times per second), (e) a minimum time duration or refractory period between consecutive saccade movements (e.g., about 100-200 ms separating two consecutive saccade movements), (f) a maximum duration for fixations (e.g., fixations lasting less than about 600 ms), (g) relationships between amplitude, duration, and/or velocity of saccades (e.g., a generally linear relationship between amplitude and duration or between amplitude and velocity), and/or other inconsistent eye movement results, such as translations of the eyeball out of the head or rotations too far into the head. Other rules and associated eye movement parameters may be defined as well.

The measured variables may be compared against the model parameters to determine whether or not the eye-tracking signal corresponds to eye movement that violates the rules. If the eye-tracking signal violates the rules, the derived eye movement may be deemed to be non-physical eye movement, in which case the eye-tracking signal may be considered erroneous or unreliable. In response to determining that an eye-tracking signal is, or has become, erroneous or unreliable, a system using the signal (e.g., a HMD) may take one or more corrective and/or evasive actions in connection with processes, programs, or applications that use the gaze signal as input, for example.

c. Adapted Operation of Eye-Tracking

In accordance with example embodiments, the HMD may be caused to suspend or terminate one or more applications that are impacted by the erroneous or unreliable eye-tracking signal, or to suggest or advise that the one or more applications that are impacted by the erroneous or unreliable eye-tracking signal be suspended or terminated. Further, notifications, alerts, suggestions, and/or advisements presented or issued by the HMD may be considered as being directed to a user of the HMD, although other types of recipients are possible as well.

More particularly, when an eye-tracking signal is deemed erroneous or unreliable, one or more corrective, compensating, preventive, or preemptive actions may be taken. Possible actions include, for example, turning off a Kalman filter (or other filter), recalibrating the eye-tracking system, and/or alerting or notifying a user of the unreliable eye-tracking signal, among others. The alert or notification may take the form of a text message, visual cue, audible cue, or some other presentation at the HMD.

The alert or notification may further indicate which, if any, applications are impacted by the erroneous or unreliable eye-tracking signal. Such notification can also identify one or more applications that use eye-tracking as input. The identification can be used to issue a further notification that the one or more applications may behave erroneously, or that use of the one or more applications should be suspended or terminated. Alternatively or additionally, operation of the one or more applications could be suspended upon determination of an erroneous eye-tracking signal, or a suggestion can be made that the one or more applications that are impacted by the erroneous or unreliable eye-tracking signal be suspended or terminated.

Further, notifications, alerts, suggestions, and/or advisements presented or issued by the HMD may be considered as being directed to a user of the HMD, although other types of recipients are possible as well.

In further accordance with the example embodiment, the notification could include an indication of one or more corrective actions that could be taken to reduce or eliminate the excessive level of ambient-light interference. For example, the indication could be to reorient the HMD away from a source of interfering light. Alternatively or additionally, the indication could be to shade the HMD or the eye-tracking device of the HMD from the interfering light.

In accordance with example embodiments, upon a determination that a noise level of an erroneous eye-tracking signal has dropped below a threshold level, use of eye-tracking as input to the one or more applications may be resumed. A notification of resumption may also be issued. If suspension of use of input was automatic (e.g., without active user interaction), resumption may also be automatic.

d. Example Method

The example embodiments for determining quality of an eye-tracking signal based on physical characteristics of an eye described above in operational terms of can be implemented as a method on a wearable HMD equipped with an eye-tracking device. The method could also be implemented on a server (or other computing device or platform) external to the HMD. An example embodiment of such a method is described below.

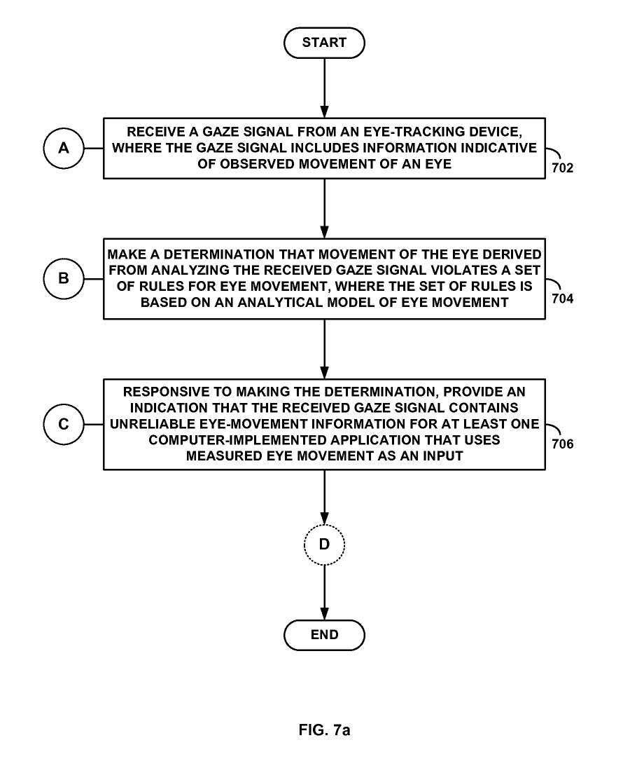

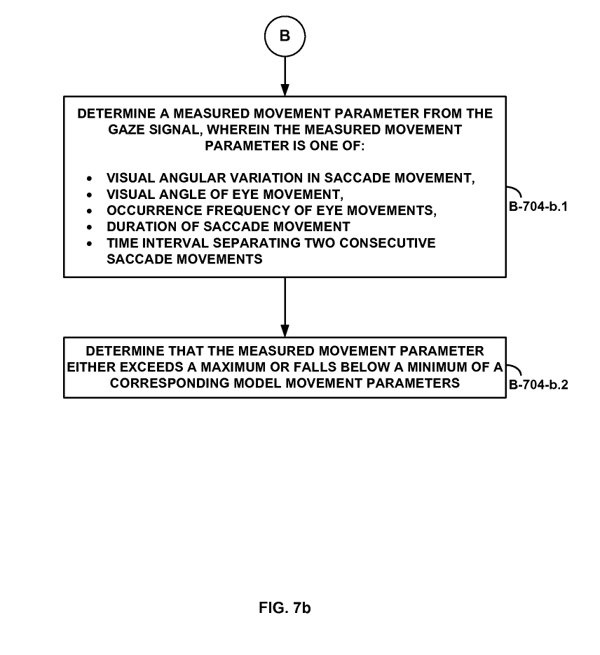

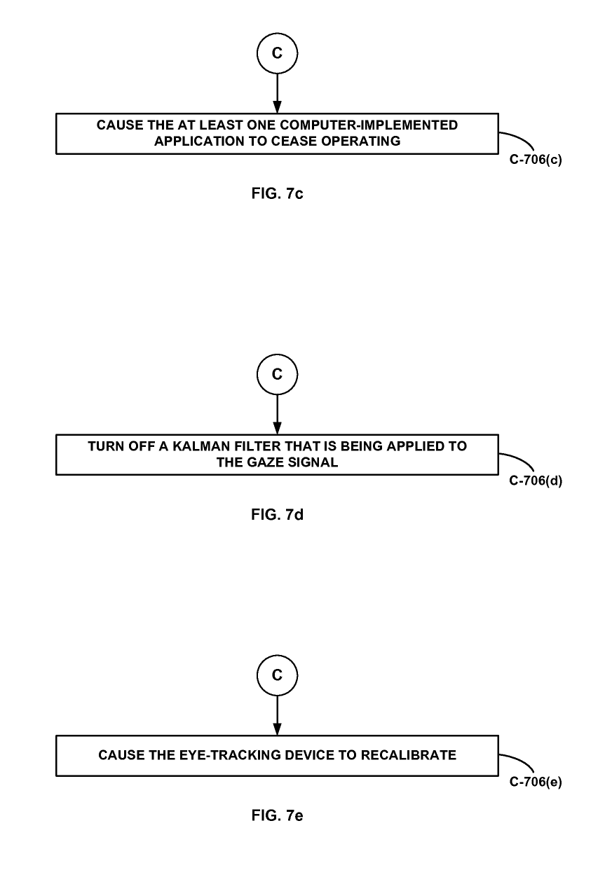

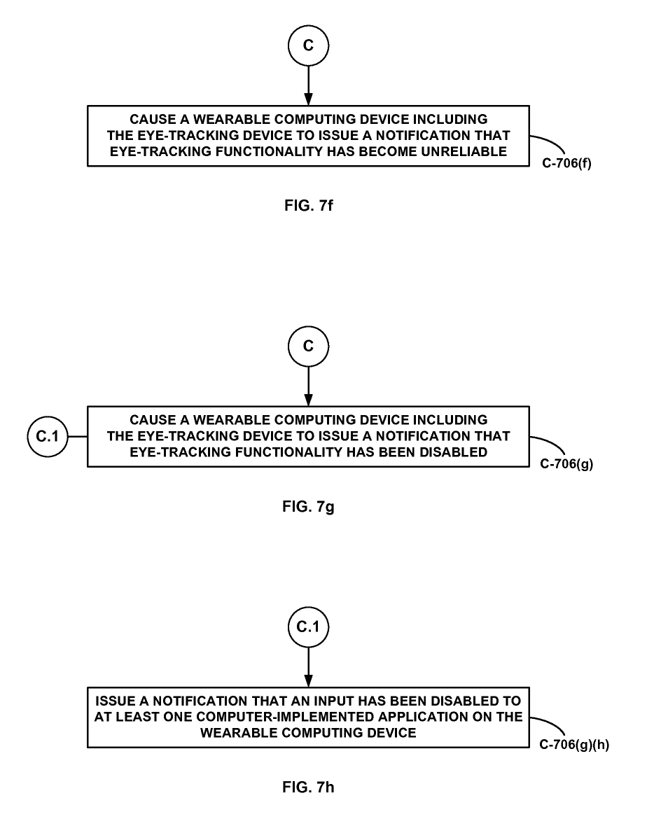

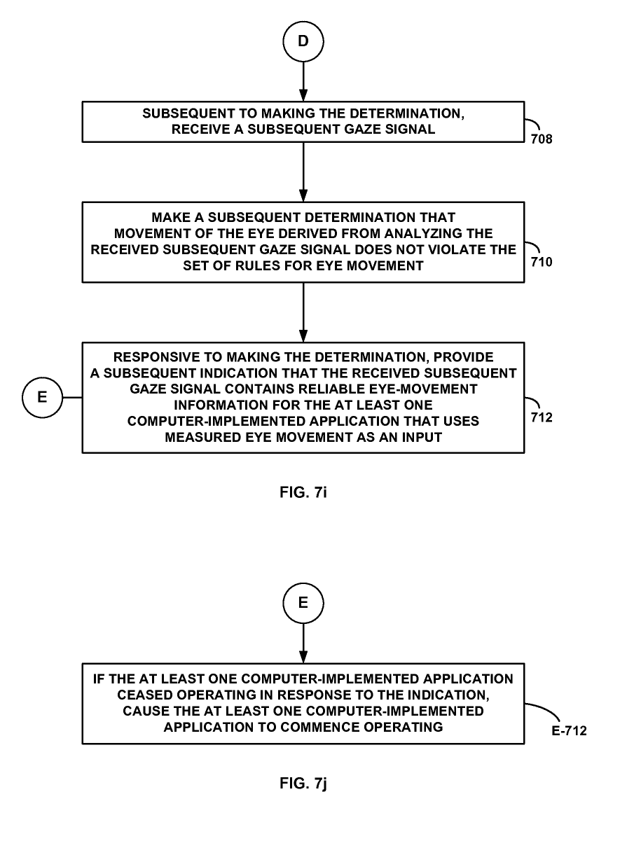

FIG. 7 is a flowchart illustrating an example embodiment of a method in a wearable computing system, such as a wearable HMD, for determining ambient-light interference with eye-tracking data. The illustrated steps of the flowchart could be implemented in the wearable head-mounted display as executable instructions stored in one or another form of memory, and executed by one or more processors of the wearable head-mounted display. Alternatively, the steps could be carried out in a network server, using eye-tracking data detected and transmitted by a HMD. Examples of a wearable HMD include the wearable computing system 102 in FIGS. 1a and 1b, wearable computing system 152 in FIG. 1c, wearable computing system 172 in FIG. 1d, and the wearable computing system 202 in FIG. 2. Examples of a network server included the computing devices in FIGS. 4a and 4b. The executable instructions could also be stored on some form of non-transitory tangible computer readable storage medium, such as magnetic or optical disk, or the like, and provided for transfer to the wearable head-mounted display's memory, the server's memory, or some both, during configuration or other procedure(s) for preparing the wearable head-mounted display and/or the server for operation.

As shown, at step 702, a computing device receives a gaze signal or eye-tracking data from an eye-tracking device. In accordance with example embodiments, the gaze signal could include information indicative of observed movement of an eye.

At step 704, the computing device determines whether movement of the eye derived from analyzing the received gaze signal violates a set of rules for eye movement, In accordance with example embodiments, the set of rules could be based on an analytical model of eye movement.

At step 706, the computing device responds to the determination of step 704 that the gaze signal violates one or more rules for eye movement, by providing an indication that the received gaze signal contains unreliable eye-movement information for at least one computer-implemented application that uses measured eye movement as an input.

In accordance with example embodiments, the analytical model of eye movement could include physical parameters, such as mass of an eye, mass of an eyelid, a minimum speed of eye movement, a maximum speed of eye movement, a physical force to which an eye is subject. Also in accordance with example embodiments, the set of rules for eye movement could include model movement parameters, such as a minimum visual angular variation in saccade movement, a maximum visual angular variation in saccade movement, a maximum visual angle of eye movement, a minimum duration of saccade movement, a maximum duration of saccade movement, a maximum occurrence frequency of eye movements, and a minimum time interval separating any two consecutive saccade movements.

In further accordance with example embodiments, making the determination that the derived eye movement violates the set of rules for eye movement could correspond to determining that one or more measured movement parameters derived from the gaze signal falls outside of one or another threshold range. For example, a measured movement parameter might be determined to exceed a maximum parameter value of a corresponding one of the model movement parameters, or be determined to fall below a minimum parameter value of the corresponding one of the corresponding one of the model movement parameters. By way of example, a measured movement parameter could correspond to one of a measured visual angular variation in saccade movement, a measured visual angle of eye movement, a measured duration of saccade movement, a measured occurrence frequency of eye movements, a measured duration of saccade movement, and a measured time interval separating two consecutive saccade movements.

In accordance with example embodiments, providing the indication that the received gaze signal contains unreliable eye-movement information could correspond to causing the computer-implemented application that uses measured eye movement as an input to cease operating. By way of example, computer-implemented application could a Kalman filter that is applied to the gaze signal. In this case, providing the indication that the received gaze signal contains unreliable eye-movement information could correspond to excluding the unreliable data (“turning off” the Kalman filter). As will be appreciated, the gaze signal could be input to a digital signal processor, and the Kalman filter could be implemented as one or more analytical steps of signal processing. In addition to excluding errant data, turning the Kalman filter on and off could correspond to activating and deactivating the filter operations in the signal processing. As a further possibility, providing the indication that the received gaze signal contains unreliable eye-movement information could correspond to causing the eye-tracking device to recalibrate.

In further accordance with example embodiments, at some point after determining that the eye movement derived from the gaze signal violates the set of rules for eye movement, a subsequent determination may be made that eye movement derived from analyzing a subsequent gaze signal does not violate the set of rules for eye movement. In response to the subsequent determination, the computing device could provide a new or updated indication that the subsequent gaze signal again contains reliable eye-movement information for the computer-implemented application that uses measured eye movement as an input. If the computer-implemented application had ceased operating (e.g., if the computing device had ceased operation of the application) in response to the original indication at step 706, providing the new or updated indication could causing the computer-implemented application to commence operating again. The subsequent gaze signal could be continuous with the previous gaze signal that was determined to be erroneous and/or unreliable. Alternatively, the subsequent gaze signal might not necessarily be continuous with the previous signal.

In accordance with example embodiments, the eye-tracking device could be part of a wearable computing device, such as a HMD. In this case, providing the indication that the received gaze signal contains unreliable eye-movement information could correspond to causing the wearable computing device to issue a notification that eye-tracking functionality has become unreliable, or that the eye-tracking functionality has been disabled. In addition to issuing the notification, the wearable computing device could also issue a notification that the computer-implemented application that uses measured eye movement as an input has been disabled.

It will be appreciated that the steps shown in FIG. 7 are meant to illustrate operation of an example embodiment. As such, various steps could be altered or modified, the ordering of certain steps could be changed, and additional steps could be added, while still achieving the overall desired operation.

### CONCLUSION

An illustrative embodiment has been described by way of example herein. Those skilled in the art will understand, however, that changes and modifications may be made to this embodiment without departing from the true scope and spirit of the elements, products, and methods to which the embodiment is directed, which is defined by the claims.

1. In a computing device, a computer-implemented method comprising:
at the computing device, receiving a gaze signal from an eye-tracking device, the gaze signal including information indicative of observed movement of an eye;
at the computing device, making a determination that movement of the eye derived from analyzing the received gaze signal violates a set of rules for eye movement, the set of rules being based on an analytical model of eye movement, wherein eye mass is one of one or more physical parameters of the analytical model of eye movement; and
responsive to making the determination, providing an indication that the received gaze signal contains unreliable eye-movement information for at least one computer-implemented application that uses measured eye movement as an input.

2. The method of claim 1, wherein the analytical model of eye movement includes additional physical parameters, the additional physical parameters being at least one of mass of an eyelid, a minimum speed of eye movement, a maximum speed of eye movement, a physical force to which an eye is subject.

3. The method of claim 1, wherein the set of rules for eye movement includes model movement parameters, the model movement parameters being at least one of a minimum visual angular variation in saccade movement, a maximum visual angular variation in saccade movement, a maximum visual angle of eye movement, a minimum duration of saccade movement, a maximum duration of saccade movement, a maximum occurrence frequency of eye movements, and a minimum time interval separating any two consecutive saccade movements.

4. The method of claim 3, wherein making the determination comprises:
determining a measured movement parameter from the gaze signal, the measured movement parameter being one of a measured visual angular variation in saccade movement, a measured visual angle of eye movement, a measured duration of saccade movement, a measured occurrence frequency of eye movements, and a measured time interval separating two consecutive saccade movements; and
determining that the measured movement parameter either exceeds a maximum or falls below a minimum of a corresponding one of the model movement parameters.

5. The method of claim 1, wherein providing the indication that the received gaze signal contains unreliable eye-movement information for the at least one computer-implemented application that uses measured eye movement as an input comprises:
causing the at least one computer-implemented application to cease operating.

6. The method of claim 1, wherein the at least one computer-implemented application is a Kalman filter that is applied to the gaze signal,
and wherein providing the indication that the received gaze signal contains unreliable eye-movement information for the at least one computer-implemented application that uses measured eye movement as an input comprises turning the Kalman filter off.

7. The method of claim 1, wherein providing the indication that the received gaze signal contains unreliable eye-movement information for the at least one computer-implemented application that uses measured eye movement as an input comprises:
causing the eye-tracking device to recalibrate.

8. The method of claim 1, further comprising:
subsequent to making the determination, receiving a subsequent gaze signal;
making a subsequent determination that movement of the eye derived from analyzing the received subsequent gaze signal does not violate the set of rules for eye movement; and
responsive to making the subsequent determination, providing a subsequent indication that the received subsequent gaze signal contains reliable eye-movement information for the at least one computer-implemented application that uses measured eye movement as an input.

9. The method of claim 8, wherein providing the subsequent indication that the received subsequent gaze signal contains reliable eye-movement information for the at least one computer-implemented application that uses measured eye movement as an input comprises:
if the at least one computer-implemented application ceased operating in response to the indication, causing the at least one computer-implemented application to commence operating.

10. The method of claim 1, wherein the eye-tracking device is part of a wearable computing device,
and wherein providing the indication that the received gaze signal contains unreliable eye-movement information for the at least one computer-implemented application that uses measured eye movement as an input comprises:
causing the wearable computing device to issue a notification that eye-tracking functionality has become unreliable.

11. The method of claim 1, wherein the eye-tracking device is part of a wearable computing device,
and wherein providing the indication that the received gaze signal contains unreliable eye-movement information for the at least one computer-implemented application that uses measured eye movement as an input comprises:
causing the wearable computing device to issue a notification that eye-tracking functionality has been disabled.

12. The method of claim 11, wherein causing the wearable computing device to issue the notification that eye-tracking functionality has been disabled comprises causing the wearable computing device to issue a notification that the at least one computer-implemented application on the wearable computing device that uses measured eye movement as an input has been disabled.

13. A computing device comprising:
one or more processors;
memory; and
machine-readable instructions stored in the memory, that upon execution by the one or more processors cause the system to carry out operations comprising:
receiving a gaze signal from an eye-tracking device, wherein the gaze signal includes information indicative of observed movement of an eye,
making a determination that movement of the eye derived from analyzing the received gaze signal violates a set of rules for eye movement, wherein the set of rules is based on an analytical model of eye movement, wherein eye mass is one of one or more physical parameters of the analytical model of eye movement, and
responding to making the determination by providing an indication that the received gaze signal contains unreliable eye-movement information for at least one computer-implemented application that uses measured eye movement as an input.

14. The computing device of claim 13, wherein the analytical model of eye movement includes additional physical parameters, the additional physical parameters being at least one of mass of an eyelid, a minimum speed of eye movement, a maximum speed of eye movement, a physical force to which an eye is subject,
and wherein the set of rules for eye movement includes model movement parameters, the model movement parameters being at least one of a minimum visual angular variation in saccade movement, a maximum visual angular variation in saccade movement, a maximum visual angle of eye movement, a minimum duration of saccade movement, a maximum duration of saccade movement, a maximum occurrence frequency of eye movements, and a minimum time interval separating any two consecutive saccade movements.

15. The computing device of claim 14, wherein making the determination comprises:
determining a measured movement parameter from the gaze signal, the measured movement parameter being one of a measured visual angular variation in saccade movement, a measured visual angle of eye movement, a measured duration of saccade movement, a measured occurrence frequency of eye movements, and a measured time interval separating two consecutive saccade movements; and
determining that the measured movement parameter either exceeds a maximum or falls below a minimum of a corresponding one of the model movement parameters.

16. The computing device of claim 13, wherein providing the indication that the received gaze signal contains unreliable eye-movement information for the at least one computer-implemented application that uses measured eye movement as an input comprises:
causing the computing device to issue a notification, the notification being least one of a message that eye-tracking functionality has become unreliable or a message that eye-tracking functionality has been disabled.

17. A non-transitory computer-readable medium having instructions stored thereon that, upon execution by one or more processors of a computing device, cause the computing device to carry out operations comprising:
at the computing device, receiving a gaze signal from an eye-tracking device, wherein the gaze signal includes information indicative of observed movement of an eye;
at the computing device, making a determination that movement of the eye derived from analyzing the received gaze signal violates a set of rules for eye movement, wherein the set of rules is based on an analytical model of eye movement, wherein eye mass is one of one or more physical parameters of the analytical model of eye movement; and
responsive to making the determination, providing an indication that the received gaze signal contains unreliable eye-movement information for at least one computer-implemented application that uses measured eye movement as an input.

18. The non-transitory computer-readable medium of claim 17, wherein the analytical model of eye movement includes additional physical parameters, the additional physical parameters being at least one of mass of an eyelid, a minimum speed of eye movement, a maximum speed of eye movement, a physical force to which an eye is subject,
and wherein the set of rules for eye movement includes model movement parameters, the model movement parameters being at least one of a minimum visual angular variation in saccade movement, a maximum visual angular variation in saccade movement, a maximum visual angle of eye movement, a minimum duration of saccade movement, a maximum duration of saccade movement, a maximum occurrence frequency of eye movements, and a minimum time interval separating any two consecutive saccade movements,
and wherein making the determination comprises:
determining a measured movement parameter from the gaze signal, the measured movement parameter being one of a measured visual angular variation in saccade movement, a measured visual angle of eye movement, a measured duration of saccade movement, a measured occurrence frequency of eye movements, and a measured time interval separating two consecutive saccade movements; and
determining that the measured movement parameter either exceeds a maximum or falls below a minimum of a corresponding one of the model movement parameters.

19. The non-transitory computer-readable medium of claim 17, wherein the at least one computer-implemented application is a Kalman filter that is applied to the gaze signal,
and wherein providing the indication that the received gaze signal contains unreliable eye-movement information for the at least one computer-implemented application that uses measured eye movement as an input comprises turning the Kalman filter off.

20. A wearable computing system comprising:
an interface for a head-mountable display (HMD), wherein the HMD is configured to display information;
an interface for a first sensor configured to obtain eye-movement data; and
a processor configured to:
compare the eye-movement data to one or more rules for eye movement, wherein the one or more rules are based on physical parameters of an eye, the physical parameters including at least eye mass; and
responsive to determining that the eye-movement data violates at least one of the one or more rules, provide an indication that the eye-movement data is unreliable for at least one computer-implemented application that uses measured eye movement as an input.
